(19) United States
(12) Patent Application Publication
(10) Pub. No.: US 2024/0240693 A1
(43) Pub. Date: Jul. 18, 2024

(54) CONNECTION ELEMENT FOR CONNECTING BELT ENDS, AND BELT CONNECTION

(71) Applicant: SIT ANTRIEBSELEMENTE GMBH, Brakel (DE)

(72) Inventors: Dominik ARNDT, Brakel (DE); Martin HAPPE, Brakel (DE)

(73) Assignee: SIT ANTRIEBSELEMENTE GMBH, Brakel (DE)

(21) Appl. No.: 18/579,728

(22) PCT Filed: Jul. 8, 2022
(86) PCT No.: PCT/DE2022/100491

§ 371 Date: Jan. 16, 2024

(30) Foreign Application Priority Data
Jul. 16, 2021 (DE) 10 2021 118 487.8

(51) Int. Cl. F16G 3/02

(52) U.S. Cl. CPC F16G 3/02

(57) ABSTRACT

The invention relates to a connection element, more particularly a connection pin, for connecting belt ends (15), more particularly driving belts, transport belts, drive belts or toothed belts, wherein at least one protrusion (12, 22) is provided on the surface of the connection element (11, 21), which protrusion can be brought into contact with and into engagement with the belt material. The invention also relates to a belt connection for connecting a plurality of belt ends (15) by means of at least one connection element (11, 12) of this type, wherein the connection element (11, 21) penetrates and thereby connects all the belt ends (15).

The invention relates to a connection element for connecting belt ends and a belt connection as claimed in the preamble of claims 1 and 7.

Connected belt ends, for example in the case of transport belts, are subjected to high forces in some cases at the connection between the belt ends. Nevertheless, the connections between the belt ends should remain reliably intact because removing the connection could lead to a stoppage of the conveyor system, for example, resulting in high downtime costs.

Belt ends are frequently connected to one another by means of inserted pins. However, since the pins have a smooth surface or a thread, and particularly in the case of continuously joined belts, torque and walking forces generated by redirection via rollers, for example, are applied to the connection points and therefore to the pins, the pins start to work their way out of the belt ends.

When there are appropriate tensile forces, the pin can also bend and belt sections involved in the connection can slip off the pin and thereby weaken the connection still further.

As a result of this, the pins protrude from the sides of the belt and can block the rotation of the belt and the entire system. The pins can also work completely out of the belt and then cause damage in the system. Belt sections involved in the connection can slip off the pin. The belt can be separated as a result of this and the connection between the belt ends can come loose.

The object of the present invention is therefore to propose a new connection element for connecting belt ends and a new belt connection that avoids the aforementioned disadvantages.

This object is solved by the present invention with the features of claims 1 and 7.

Advantageous embodiments of the invention are the subject matter of the dependent claims.

According to the invention, the object is achieved by a connection element, in particular a connection pin, for connecting belt ends, in particular driving belts, transport belts, drive belts, or toothed belts, by providing at least one rib on the surface of the connection element that can be brought into contact with, and into engagement with, the belt material.

The connection element may, in principle, be designed in any connecting manner. Its cross-section may also, in principle, be designed in any manner. Cylindrically formed connection elements with a round cross-section, for example in the form of a pin, are frequently used.

Belt ends are connected by means of the connection element. These belt ends may, for example, but not exclusively, be parts of driving belts in drive systems, transport belts in transport systems, drive belts on motors, or also toothed belts. What all these applications have in common is that the belt ends are therefore joined, that is connected, in order to obtain an endless belt. The connection of the belt ends must therefore be able to withstand a tensile force applied to the belt and, consequently, also to the belt end connection. A high connection quality is therefore very important.

As described above, continuously connected belts are frequently redirected via rollers, for example. This results in bending moments and walking forces or walking work being exerted on the belt end connection, and therefore a torque on the connection elements located therein. It must be avoided that a connection element works its way out of the belt end connection on account of this torque.

To achieve this, at least one rib is provided on the surface of the connection element, which can be brought into contact with, and into engagement with, the belt material. In other words, the rib is therefore held in place through engagement with the belt material and is secured against displacement within the belt end. This effect increases with increasing force on the connection.

A rib can be formed on the body of the connection element either by a raised portion and/or by a recess. In other words, the rib can be formed on the body of the connection element by a method that adds material and/or removes material and/or shapes the material.

The contour of the rib is generally arbitrary. For example, the rib may have a pointed contour, a rounded contour, and/or a serrated contour. What is decisive, however, is that the rib can be brought into engagement with the belt material by a contour that is raised relative to its surroundings.

If the body of the connection element is made of solid material, it provides exceptional stability.

According to an advantageous embodiment, the rib is ring-shaped. Unlike a spiral threaded rib, ring-shaped means that the rib is arranged within a plane that is perpendicular to the longitudinal axis of the connection element. The rib may be circumferentially designed in such a manner that it encloses the entire circumference of the connection element. However, the rib may also be formed in segments along the circumference within the aforementioned plane.

By arranging the rib or the rib segments within the plane standing perpendicular to the longitudinal axis, in other words, rotationally symmetrically, the connection element can rotate about the longitudinal axis if a torque is applied to it. However, the connection element is also thereby prevented from advancing along its longitudinal axis and from working its way out laterally from the belt end.

According to another advantageous embodiment, the rib is designed circumferentially and in a spiral shape as the first threaded rib, and at least a second threaded rib is provided counter to the first threaded rib.

If only one threaded rib were provided, the connection element would work its way out of the connected belt ends like a screw spirally along the threaded rib when rotated about the longitudinal axis, something that needs to be prevented.

Therefore, a second threaded rib is provided, which is spirally wound in the opposite direction. This effectively prevents rotation about the longitudinal axis when a torque is applied to the connection elements, and thereby also prevents the connection element from working its way out laterally.

In accordance with another advantageous embodiment, the rib has at least two flanks that converge at an acute angle to one another. This sharpens the rib on its edge and allows it to cut to a certain extent into the surface of the belt ends being connected, and to grip them. The stronger a tensile force on the belt end connection, the deeper the rib edge cuts into the surface and the firmer it grips. A form-fit connection is created.

According to another advantageous embodiment, multiple ribs are provided only at the end regions of the connection element. This offers the advantage that the central region of the connection element is not weakened by raised or recessed areas when the ribs are formed.

According to another advantageous embodiment, the connection element is designed as a hollow cylinder. This provides the advantage of weight saving while still maintaining moderate bending stability.

Furthermore, according to the invention, the object is solved by a belt connection for connecting multiple belt ends with at least one connection element as described earlier, wherein the connection element passes through, and thereby connects, all the belt ends.

With this connection variant, the belt ends overlap at least sectionally, so that they lie side by side or on top of one another in this region, creating an overlap. The previously described connection element passes through the belt ends being connected.

In other words, the connection element is threaded through the belt ends being connected in such a manner that they create a form-fit connection through the connection element.

In accordance with an advantageous embodiment, the belt ends each have at least one receiving region for accommodating the connection element, wherein the receiving region has an elastic surface at least sectionally, with which the rib of the connection element is brought into engagement.

The strength of the connection is thereby further strengthened against external forces. The elastic surface of the receiving region of the belt end essentially acts as a receiving chuck for the rib of the connection element. The rib presses its own receiving bed into the elastic surface almost like a furrow.

Due to the elasticity, the rib can anchor and hold itself particularly well in the direction of movement of the belt within the receiving region. The greater the tensile force on the belt ends, the deeper the rib presses into the elastic surface, and the firmer the connection element is held in place, preventing lateral slippage perpendicular to the direction of movement of the belt.

Multiple embodiments are illustrated in the figures and will be explained below by way of example.

In the drawings:

FIG. 1 shows a first embodiment of a connection element with multiple ribs in the lateral end regions,

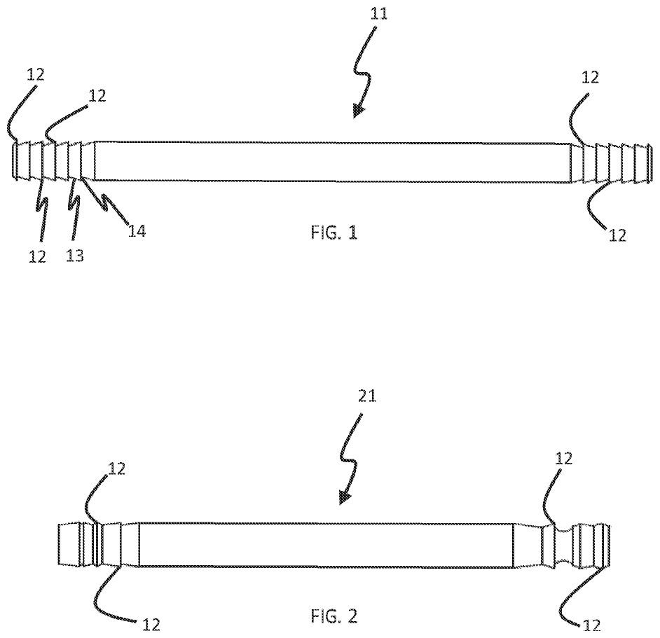

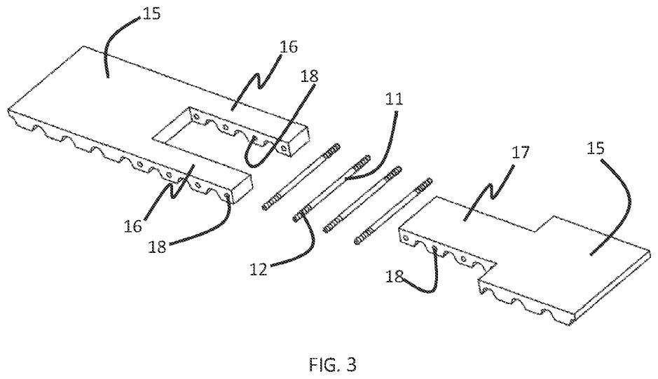

FIG. 2 shows a second embodiment of a connection element with differently shaped ribs in the lateral end regions,

FIG. 3 shows an exploded view of a belt connection with four connection elements according to FIG. 1.

FIG. 1 shows a first embodiment of a connection element 11 with multiple ribs 12 in the lateral end regions. The central area does not have any ribs. This makes it easier, on the one hand, to insert into a receiving channel of a belt end and, on the other hand, the central region is not weakened as a result of this.

The connection element 11 is made of solid material and is designed as a cylindrical elongated pin. The ribs 12 in this case result from depressions between the ribs 12.

The ribs 12 are circumferentially formed as rings in this case and not as spirals—even though this would be possible, as described above. Each rib 12 in this case lies in a plane standing perpendicularly to the longitudinal axis of the pin.

Each rib 12 in this case has two flanks 13, 14 that converge at an acute angle to one another. This gives the ribs 12 a sharp, cutting profile. This enables them to grip firmly into the surface of a receiving channel of a belt end.

FIG. 2 shows a second embodiment of a connection element 21 with differently shaped ribs 22 in the lateral end regions, in order to illustrate that the ribs can also have different profiles.

FIG. 3 shows an exploded view of a belt connection with four connection elements 11 according to FIG. 1.

The two belt ends 15 being connected each have belt end tongues 16, 17 in an overlapping region, which interlock with one another and therefore lie side by side.

When the belt end tongue 17 of the one belt end is inserted between the belt end tongues 16 of the other belt end, they interlock in a form-fitting manner such that the receiving channels 18 between all belt end tongues 16, 17 align and merge seamlessly with one another.

A connection element 11, in this case a connection pin, is inserted into the then continuous receiving channels 18, and passes through all belt ends 16, 17 within their receiving channels 18. In this way, the belt ends 15 are connected by means of the connection elements 11.

The receiving region, designed as a receiving channel 18 in this case, is provided with an elastic surface. The ribs 12 of the connection elements 11 can engage with this elastic surface of the receiving channels 18 and thereby be secured in a stable manner in the receiving channel 18 against lateral displacement along the insertion direction.

1. A connection element for connecting belt ends of driving belts, transport belts, drive belts, or toothed belts,
wherein at least one rib is provided on the surface of the connection element that can be brought into contact with, and into engagement with, a belt material of the driving belts, transport belts, drive belts, or toothed belts.

2. The connection element as claimed in claim 1,
wherein
the rib is ring-shaped.

3. The connection element as claimed in claim 1,
wherein
the rib is designed circumferentially and in a spiral shape as the first threaded rib, and at least a second threaded rib is provided counter to the first threaded rib.

4. The connection element as claimed in claim 1, wherein
the rib has at least two flanks that converge at an acute angle to one another.

5. The connection element as claimed in claim 1, wherein
multiple ribs are provided only at the end regions of the connection element.

6. The connection element claim 1, wherein
the connection element is designed as a hollow cylinder.

7. A belt connection for connecting multiple belt ends with at least one connection element, as claimed claim 1, wherein the connection element passes through, and thereby connects, all the belt ends.

8. The belt connection as claimed in claim 7,
wherein
the belt ends each have at least one receiving region for accommodating the connection element, and
the receiving region has an elastic surface at least sectionally, with which the rib of the connection element is brought into engagement.

9. The belt connection as claimed in claim 1 wherein the connection element comprises a connection pin.
